(19) United States
(12) Patent Application Publication
(10) Pub. No.: US 2018/0225610 A1
(43) Pub. Date: Aug. 9, 2018

(54) PRODUCTION PLANNING METHOD WITH EMPIRICAL CAPACITY CONSTRAINTS

(71) Applicant: National Tsing Hua University, Hsinchu City (TW)

(72) Inventors: Yi-Feng HUNG, Hsinchu City (TW); Po-Yi WU, Hsinchu City (TW)

(73) Assignee: National Tsing Hua University, Hsinchu City (TW)

(21) Appl. No.: 15/651,236

(22) Filed: Jul. 17, 2017

(30) Foreign Application Priority Data
Feb. 9, 2017 (TW) 106104229

(51) Int. Cl. G06Q 10/06

(52) U.S. Cl. CPC G06Q 10/06313; G06Q 10/06315

(57) ABSTRACT

A method of production planning includes steps of: (a) collecting sample data points for a resource type, each of the sample data points representing an individual relationship among arrival workload, initial work-in-process (WIP) workload and input workload of the resource type; and (b) establishing a capacity model that models the relationship among arrival workload, initial WIP workload and expected input workload of the resource type according to the sample data points collected in step (a), a first predetermined objective function, and a first set of predetermined constraints.

### CROSS-REFERENCE TO RELATED APPLICATION

This application claims priority of Taiwanese Patent Application No. 106104229, filed on Feb. 9, 2017.

### FIELD

The disclosure relates to a method of production planning.

### BACKGROUND

A goal of production planning systems is to satisfy the costumer's demands on time and to optimize certain performance measures, such as maximizing revenue or minimizing cost. To reach this goal, the production planning system should effectively allocate the limited capacity of various resource types among different operations of different products by calculating the raw material releases, finished goods inventory/backorder levels of various products, production input quantities and work-in-process (WIP) inventory levels of the operations on the route of various products in future periods within the planning horizon.

### SUMMARY

According to the disclosure, a method of production planning is implemented by a computer device, and includes steps of: (a) collecting sample data points for a resource type, each of the sample data points representing an individual relationship among arrival workloads, initial work-in-process (WIP) workloads and input workloads of the resource type; and (b) establishing a capacity model that models a relationship among arrival workloads, initial WIP workloads and expected input workloads of the resource type according to the sample data points collected in step (a), a first predetermined objective function, and a first set of predetermined constraints.

According to the disclosure, a method of production planning for a group of products is proposed to include steps of: (a) receiving, by a processor, a plurality of sample data pieces for a resource type from at least one of a storage device or an input device, each of the sample data pieces representing an individual relationship among arrival workloads, initial work-in-process (WIP) workloads and input workloads of the resource type; and (b) generating, by a processor, capacity model data representing a capacity model that models a relationship among arrival workloads, initial WIP workloads and expected input workloads of the resource type according to the sample data pieces received in step (a), first pre-stored objective function data representing a first predetermined objective function, and first pre-stored constraint data representing a first set of predetermined constraints.

According to the disclosure, a computer system for production planning for a group of products is proposed to include an input device, a storage device and a processor. The input device is for input operation of a user. The storage device stores first pre-stored objective function data representing a first predetermined objective function, and first pre-stored constraint data representing a first set of predetermined constraints. The processor is coupled to the input device, the storage device, and is configured to: receive a plurality of sample data pieces for a resource type from at least one of the storage device or the input device, each of the sample data pieces representing an individual relationship among arrival workloads, initial work-in-process (WIP) workloads and input workloads of the resource type; and generate capacity model data representing a capacity model that models a relationship among arrival workloads, initial WIP workloads and expected input workloads of the resource type according to the sample data pieces, the first pre-stored objective function data, and the first pre-stored constraint data.

### BRIEF DESCRIPTION OF THE DRAWINGS

Other features and advantages of the disclosure will become apparent in the following detailed description of the embodiment (s) with reference to the accompanying drawings, of which:

FIG. 1 is a flow chart illustrating steps of an embodiment of the method of production planning according to the disclosure;

FIG. 2 is a plot illustrating a relationship between initial WIP workloads and input workloads when there is no arrival material;

FIG. 3 is a plot illustrating an approximate relationship between arrival workloads and input workloads when there is no initial WIP material;

FIG. 4 is a plot illustrating a capacity model established in this embodiment;

FIGS. 5 and 6 are plots illustrating a first case and a second case in calculation input coefficients, respectively; and

FIG. 7 is a block diagram illustrating a computer system to implement the embodiment of the method.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

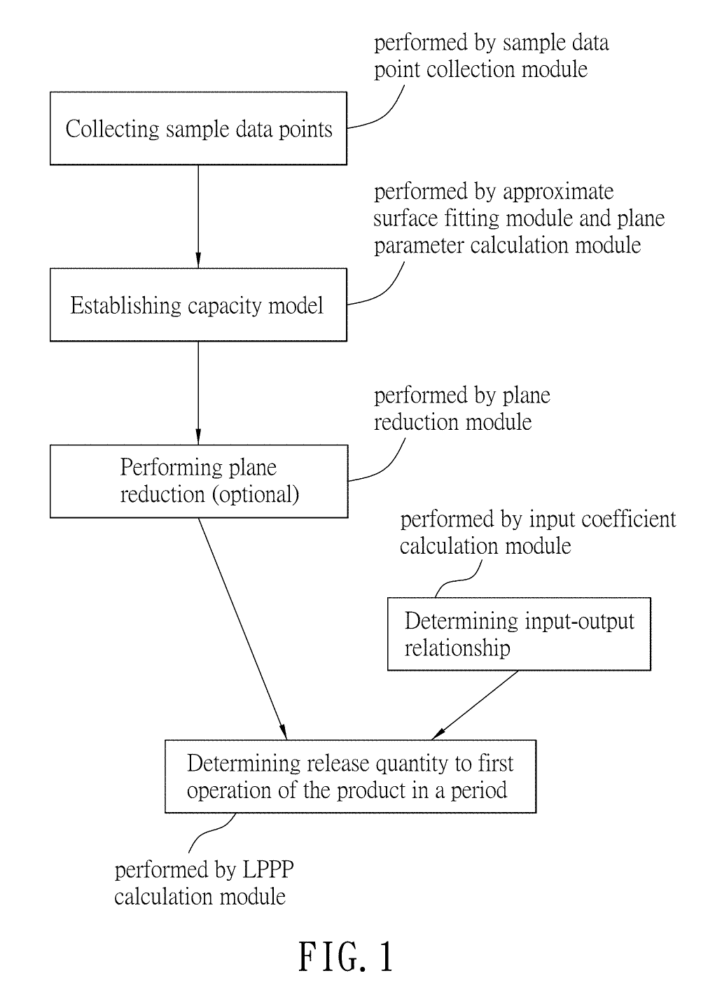

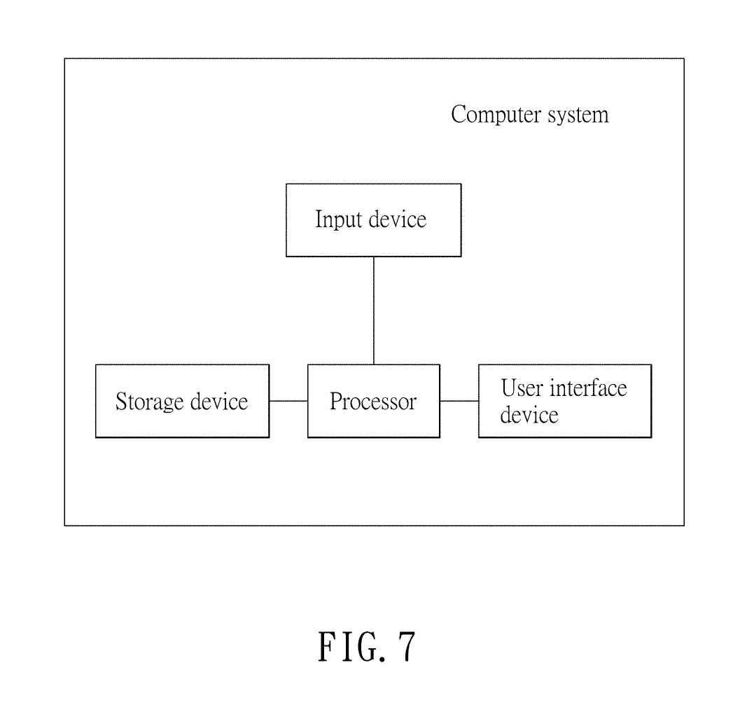

Referring to FIG. 1, an embodiment of the method of production planning according to this disclosure is a linear programming production planning (LPPP) approach incorporated with an empirical capacity constraint technique. The production planning method may be adapted for a variety of industries, such as semiconductor industry, and may be implemented by a computer system (see FIG. 7) which may include but not limited to a processor, a storage device (e.g., a hardware disk, a flash memory, a cloud storage, etc.), an input device (e.g., a keyboard, a mouse, etc.), and an user interface device (e.g., a display, a printer, etc.), and which may have network capability. It is noted that, parameters, variables, functions, models, calculation results, etc., which will be introduced hereinafter, may be stored in the storage device of the computer system, but this disclosure is not limited thereto.

Terminologies used in the description are defined as follows. A resource type is a group of similar tools that are used to perform similar value-added activities on materials. A lot is a group of materials that are transported together between various resource types and processed together on a unit of a particular resource type. An operation is an activity (for instance, processing on a machine of a workstation or transportation between workstations or factories) performed on a lot by a tool of a particular resource type (a machine or a transport equipment). To be transformed into finished goods, a lot of raw materials has to undergo a pre-specified route, which defines a sequence of operations. An operation is defined by a required resource type, required processing time per product unit (in work-hours), and time lag between input and output (or, input-output time lag) of the operation. Note that two or more operations of various products may share the same resource type, where input of a lot means a beginning of the processing on materials of the lot by a tool of the required resource type, and output of a lot means the end of the processing on materials of the lot by a unit of the required resource type. Also, the input-output time lag of an operation for a lot may be longer than the actual processing time of the operation on the lot because it may take extra time, during which the tool is not occupied, to complete the operation. Lead time of an operation (or called operation lead time) consists of waiting time for an available tool of the required resource type of the operation and the input-output time lag of the operation. Release means that a lot of materials is ready and allowed to begin its first operation. Thus, total lead time of a lot is the time between the release and the completion of the lot, which is also equal to the sum of the operation lead times of all the operations of the lot. Arrival means that materials reach the required resource type of an operation and are ready to be processed by a tool of the resource type. Arrival time of a lot to an operation may not be equal the input time of the lot to the operation because all of the tools of the required resource type may be busy with other lots or may have broken down and the arrival lot has to wait. The difference in the arrival time and the input time of a lot is the waiting time for the lot.

Work-in-process (WIP) refers to materials that are not in the form of finished goods and that are waiting for a tool to be processed or transported. A workload on a resource type refers to an aggregate processing time that is usually measured in work-hours and that is requested by a group of lots for various operations. WIP in this embodiment refers to materials that are waiting for a particular resource type at a particular time point. The WIP workload at a particular time point (or, called epoch) refers to total processing time (in work-hours) of all lots that wait for required resource types for various operations at that time.

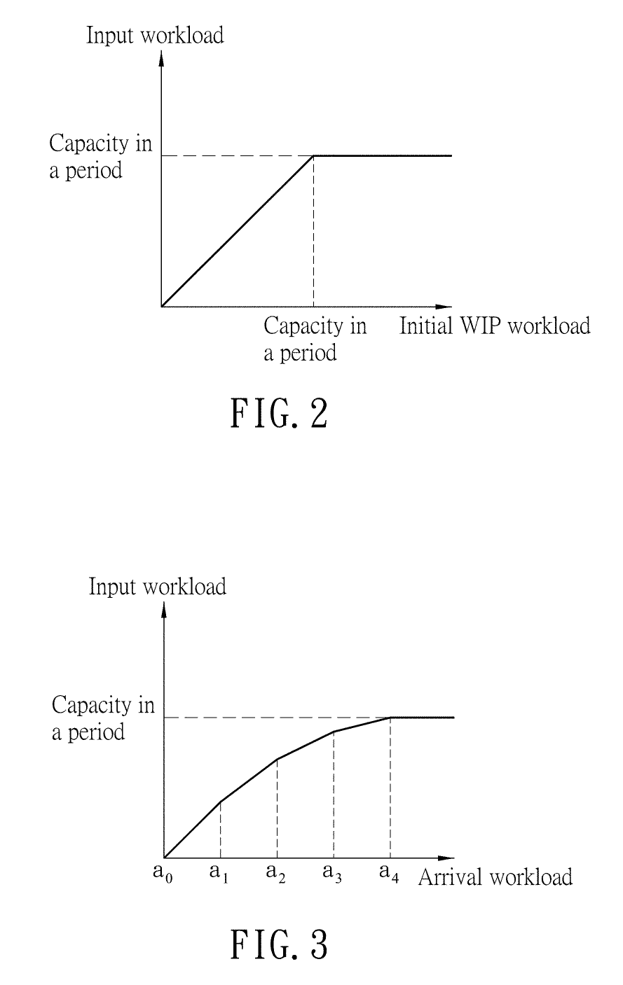

In general, a resource type has limited available capacity and a lot of materials has to wait in queue of the resource type when all tools of the resource type are unavailable. Input quantity to a resource type is constrained due to the limited capacity. Materials that can be input for processing or transport in a period come from two possible portions: one is the initial WIP (the materials waiting in the queue) at the beginning of the period and the other is the materials that arrive in the period. Under the condition of no arrival material to a resource type in a period (where the arrival material refers to material that arrives the resource type during the period), the materials of the initial WIP at the beginning of the period can be inputted to the resource type for processing/transport as long as their total capacity requirement is less than the available capacity in the period of the resource type since these materials are ready at the beginning of the period. Hence, when there is no arrival material in a period, the relationship between initial WIP workload and input workload (i.e., workload for material that is inputted to the resource type) is that as shown in FIG. 2. In FIG. 2, when the initial WIP workload in a period of a resource type is less than or equal to the available capacity in the period of the resource type, the input to the resource type in the period is equal to the initial WIP workload; when the initial WIP workload is greater than the available capacity, the input workload should remain fixed and equal to the available capacity in the period of the resource type. On the other hand, when there is no initial WIP workload at the beginning of a period of a resource type, the arrival and input workloads should have a concave relationship and thus a piece-wise linearization curve can be used to approximate this relationship as shown in FIG. 3. The concavity of the curve is enforced by having the slope of the line segment between aᵢ₋₁ and aᵢ be greater than or equal to the slope of the line segment between aᵢ and aᵢ₊₁, where i is an integer not smaller than 1.

The following indices are used to precisely and concisely describe the embodiment, and are defined as follows. An index value denotes a unique entity. For example, g denotes an index of a product. Then, g=1 denotes product No. 1, g=2 denotes product No. 2, g=3 denotes product No. 3, etc. The indices used herein include:

g: an index of a product;

G: a set of all products;

p,q: an index of a period, p=1, . . . , P, q=1, . . . , P, where P denotes the last period;

t: an index of a period in a historical database or simulation, or an index of a sample data point;

l: an index of an operation;

L(g): the last operation of a product g;

k: an index of a resource type;

K: a set of all resource types;

i: an index of an end point on an x-axis, an index of an approximate plane, or an index of a triangle on an x-y plane of z=0 for empirical capacity model of a resource type, where i=0, 1, . . . , I, where I is a predetermined parameter which will be described later; and

j: an end point index on a y-axis, where j=0 or 1.

Various notations are defined in the following presentation. A notation represents a data table or file in computer database systems. For example, u_{gl} denotes processing time per product unit of an operation l of a product g. For example, a data table of u_{gl} may look like Table 1, which shows that the processing time per product unit of operations 1, 2 and 3 of a product 1 are 2.0, 1.5, and 1.8 hours, respectively, and the processing time per product unit of the operations 1, 2 and 3 of a product 2 are 1.0, 1.2, and 1.6 hours, respectively.

TABLE 1

| | | u_{gl} |
|---|---|---|
| g | l | processing time per |
| product | operation | product unit |
| 1 | 1 | 2.0 |
| 1 | 2 | 1.5 |
| 1 | 3 | 1.8 |
| 2 | 1 | 1.0 |
| 2 | 2 | 1.2 |
| 2 | 3 | 1.6 |

The embodiment of the production planning method uses an LPPP model including a sample data point collection module, an approximate surface fitting module, a plane parameter calculation module, a plane reduction module, an input coefficient calculation module, and an LPPP calculation module, which may be realized by a processor executing a software program.

The sample data point collection module collects sample data points for each resource type to build a relationship among initial WIP workloads, arrival workloads and input workloads of a period for the resource type. Each of the sample data points has an individual relationship among arrival workloads, initial WIP workloads and input workloads of the resource type. The sample data points may be collected from a manufacturing database system which may be built in the storage device, from a simulation program that simulates the actual manufacturing system, or from user input through the input device.

The sample data point collection module calculates the initial WIP workload, the arrival workload and the input workloads in a period by multiplying their respective quantities (in product units) by the processing time per product unit of the associate operation. The procedure to calculate three-coordinate values of sample data points is described as follows.

The sample data point collection module has module input data, module output data, and a module procedure listed as follows.

The module input data of the sample data point collection module includes:

u_{gl}: processing time (in work-hours) per product unit of an operation l of a product g;

Q_{gtl}: an arrival quantity (in product units) to an operation l of a product g in a period t;

M_{gtl}: a WIP level (in product units) of an operation l of a product g at the beginning of a period t;

E_{gtl}: an input quantity (in product units) to an operation l of a product g in a period t; and

k′_{gl}: a resource type required by an operation l of a product g.

The module output data of the sample data point collection module includes:

\tilde{x}ₖₜ: arrival workload (in work-hours) of a resource type k in a period t;

\tilde{y}ₖₜ: WIP workload (in work-hours) of a resource type k at a beginning of a period t; and

\tilde{z}ₖₜ: input workload (in work-hours) of a resource type k in a period t.

The module procedure of the sample data point collection module is that:

```
For each k
    {
    For each t
        {
        \tilde{x}ₖₜ = Σ_{{(g,l)|k}_{_{gl}}_{′=k}} u_{gl}Q_{gtl}
        \tilde{y}ₖₜ = Σ_{{(g,l)|k}_{_{gl}}_{′=k}} u_{gl}M_{gtl}
        \tilde{z}ₖₜ = Σ_{{(g,l)|k}_{_{gl}}_{′=k}} u_{gl}E_{gtl}
        }
    }
```

For a resource type k, the values of the three coordinates of a data point t are (\tilde{x}ₖₜ, \tilde{y}ₖₜ, \tilde{z}ₖₜ). Then, the available capacity model of the resource type k is empirically constructed from (\tilde{x}ₖₜ, \tilde{y}ₖₜ, \tilde{z}ₖₜ) ∀t.

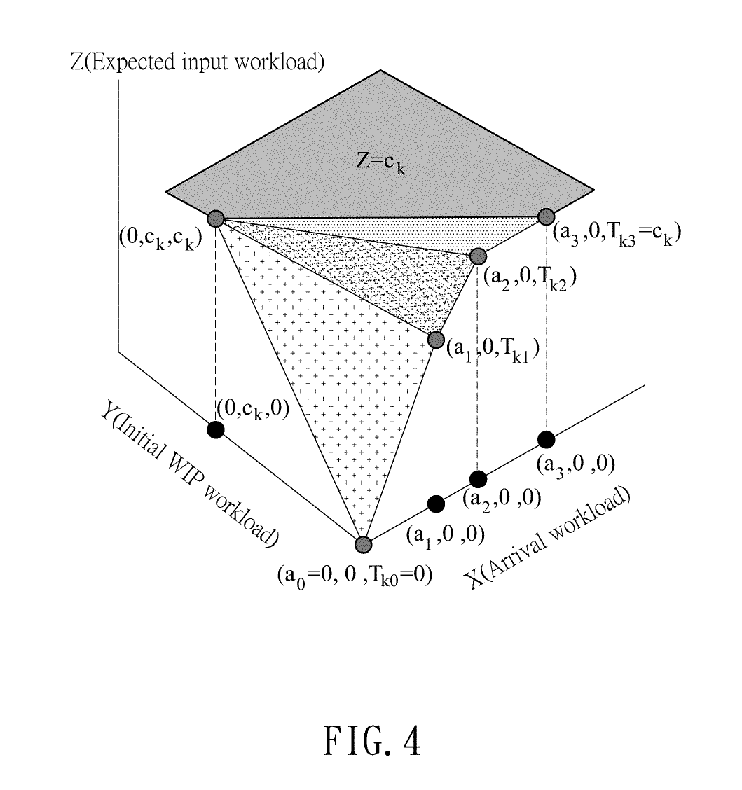

Referring to FIG. 4, the approximate surface fitting module establishes a capacity model of a resource type by approximate plane-wise linearization surface according to the abovementioned two primitive relationships (i.e. the relationships respectively illustrated in FIGS. 2 and 3) among the initial WIP workload, arrival workload and input workload of a resource type by extrapolation. The approximate surface fitting module constructs an approximate plane-wise surface for the resource type k by fitting a curved surface constructed by the sample data points based on an objective function and a set of predetermined constraints to establish the capacity model. The two primitive relationships are: (1) the relationship between initial WIP workload and input workload in a period when there is no arrival lot (see FIG. 2); and (2) the relationship between arrival workload and input workload in a period when there is no initial WIP (see FIG. 3). In FIG. 4, x-, y- and z-axes denote the arrival workload, the initial WIP workload and the expected input workload, respectively, in a period of a resource type. The y-z plane of x=0 (no arrival workload) should be consistent with the relationship between initial WIP and input workloads when there is no arrival, which is shown in FIG. 2. The x-z plane of y=0 (no initial WIP) should be a piece-wise linear concave curve that relates the arrival workload to the input workload when there is no initial WIP, as shown in FIG. 3. To derive the piece-wise curve on the x-z plane of y=0, the empirical capacity technique divides the x-axis (arrival workload) into I segments, and models the expected input workloads on the end points of these I segments on the x-axis as decision variables.

In the following description, cₖ denotes an available capacity (in work-hours) in a period of a resource type k, aᵢ denotes an x-value (arrival workload) of an i-th end point on the x-axis (i=0, 1, . . . , I), and Tₖᵢ denotes an expected input workload of resource type k in a period when the arrival workload is aᵢ and the initial WIP workload is zero.

Furthermore, there is only one segment on the y-axis (no arrival workload). The y-value of the approximate plane-wise surface of the resource type k corresponds to the end point of the segment and equals cₖ, also denoted as s₁, for the resource type k. The approximate plane-wise surface of the resource type k consists of (I+1) lines that can also be indexed by i and i=0, 1, . . . , I. Line i is obtained by connecting the point (0,cₖ,cₖ) and the point (aᵢ,0,Tₖᵢ). Then, two neighboring lines i and i+1 obtained in this way determine a plane, and thus a total of (I+1) such planes can be constructed to approximate available capacity of a resource type k under different combinations of initial WIP workload and arrival workload in a period. These planes are concave because the intersection of these plane-wise surfaces and plane y=0 is a piece-wise curve that is enforced to be concave by the constraint in the surface fitting linear programming model, as described later. Concavity is essential to the LPPP model in this embodiment. Projecting the boundary line between two neighboring planes to the x-y plane of z=0 generates I triangles on the x-y plane. Note that the last plane (the (I+1)-th plane with index I) is not a triangle. The triangles on the x-y plane of z=0 and their corresponding approximate planes can both be indexed by i, which is also used to index the end points on the x-axis.

In addition, this model enforces the last plane (i.e., the (I+1)-th plane with index I) to be equal to plane z=cₖ, in which cₖ is the available capacity (in work-hours) in a period of a resource type k and is the maximum possible input workload for a resource type k in a period.

Let Ψₖᵢ be a set of all data points whose (x,y) values belong to a triangle i on the x-y plane of z=0 for a resource type k. The z-values (expected input workload) of all the data points in a triangle are projected by the corresponding plane of the approximate surface.

In this embodiment, a plane i of a resource type k is defined by three points (0,cₖ,cₖ), (aᵢ,0,Tₖᵢ), and (aᵢ₊₁,0,T_{k,i+1}) and it is used to project the expected input workload from a pair of arrival workload (x value) and initial WIP workload (y value) in a period that is in a triangle i. In addition, parameters Dₖᵢ, Aₖᵢ, and Bₖᵢ are required to describe plane i of resource type k in LPPP model and are calculated from the three points, (0,cₖ,cₖ), (aᵢ,0,Tₖᵢ), and (aᵢ₊₁, 0, T_{k,i+1}).

For each resource type k of all resource types, linear programming problem LPₖ outlined as follows can be formulated and solved to obtain the plane-wise surface to approximate the empirical capacity limits for resource type k.

The surface fitting linear programming problem LPₖ may be formulated by:

parameters of:
\tilde{x}ₖₜ: arrival workload (in work-hours) in a period of a data point t, ∀t;

\tilde{y}ₖₜ: initial WIP workload (in work-hours) at a beginning of a period of a data point t, ∀t;

\tilde{z}ₖₜ: input workload (in work-hours) in a period of a data point t, ∀t;

cₖ: available capacity (in work-hours) of resource type k in a period;

aᵢ: an x-value of the i-th end point on the x-axis, i=0, . . . , I; and

sⱼ: a y-value of the j-th end point on y-axis, where s₀=0 and s₁=cₖ;

θₖᵢ: the number of data points in Φₖᵢ;

sets of:

Ψₖᵢ:{(x,y)|cₖx+aᵢy−aᵢcₖ>0 and cₖx+aᵢ₊₁y−aᵢ₊₁cₖ≤0}i=0, . . . ,I−1; and

Ψ_{kI}:{(x,y)|cₖx+a_{I}y−a_{I}cₖ>0};

Φₖᵢ:{t|(\tilde{x}ₖₜ,\tilde{y}ₖₜ)∈Ψₖᵢ},i=0, . . . ,I;

decision variables of:

Tₖᵢ: expected input workload that can be inputted for being processed when the y-value (initial WIP workload) is zero and the x-value (arrival workload) is aᵢ, i=0, . . . , I;

Dₖᵢ: a z-intercept of a plane i, which is defined by the three points (aᵢ,0,Tₖᵢ), (aᵢ₊₁,0,T_{k,i+1}), and (0,cₖ,cₖ), i=0, . . . , I−1, and a plane I is defined as a plane of z=cₖ;

Oₖₜ: over-estimated input workload of a data point t in LPₖ, ∀t;

Uₖₜ: under-estimated input workload of a data point t in LPₖ, ∀t;

z̅ₖₜ: an expected z-value (input workload) of a data point t whose x-value is \tilde{x}ₖₜ and y-value is \tilde{y}ₖₜ and is projected by plane-wise approximation of the empirical capacity surface, ∀t;

an objective function of

$$Minimize {\sum }_{i = 0}^{I - 1} {\sum }_{t ∈ {Φ}_{ki}} \frac{1}{{θ}_{ki}} ( {O}_{kt} + {U}_{kt} ) \qquad ( 1 )$$

which is subject to constraints of:

$$\begin{matrix}{D}_{ki} = {T}_{k , i + 1} - \frac{{T}_{k , i + 1} - {T}_{ki}}{{a}_{i + 1} - {a}_{i}} \times {a}_{i + 1} i = 0 , … , I - 1 & ( 2 ) \\ {\overline{z}}_{kt} = {D}_{ki} + \frac{{T}_{k , i + 1} - {T}_{ki}}{{a}_{i + 1} - {a}_{i}} \times {\tilde{x}}_{kt} + \frac{{c}_{k} - {D}_{ki}}{{s}_{1} - {s}_{0}} \times {\tilde{y}}_{kt} , \\ ∀ t such that ( {\tilde{x}}_{kt} , {\tilde{y}}_{kt} ) ∈ {Ψ}_{ki} , i = 0 , … , I - 1 & ( 3 ) \\ {\overline{z}}_{kt} = {c}_{k} , ∀ t such that ( {\tilde{x}}_{kt} , {\tilde{y}}_{kt} ) ∈ {Ψ}_{kI} & ( 4 ) \\ {O}_{kt} - {U}_{kt} = {\overline{z}}_{kt} - {\tilde{z}}_{kt} , ∀ t & ( 5 ) \\ {T}_{k , i + 1} \geq {T}_{k , i} , i = 0 , … , I - 1 & ( 6 ) \\ \frac{{T}_{k , i + 1} - {T}_{ki}}{{a}_{i + 1} - {a}_{i}} \leq \frac{{T}_{ki} - {T}_{k , i - 1}}{{a}_{i} - {a}_{i - 1}} , i = 1 , … , I - 1 & ( 7 ) \\ {T}_{k 0} = 0 & ( 8 ) \\ {T}_{kI} = {c}_{k} & ( 9 ) \\ {D}_{kI} = {c}_{k} & ( 10 ) \\ {T}_{ki} , {D}_{ki} \geq 0 , ∀ i & ( 11 ) \\ {O}_{kt} , {U}_{kt} \geq 0 , ∀ t & ( 12 )\end{matrix}$$

Function (1) is an objective function that minimizes a sum of the absolute deviation between the expected input workload (z̅ₖₜ) and the collected input workload (z̅ₖₜ) of all data points. Constraint (2) expresses Dₖᵢ in terms of Tₖᵢ and T_{k,i+1}. Constraint (3) expresses the expected input workload of a data point t by Dₖᵢ, Tₖᵢ, and T_{k,i+1}. Constraint (4) enforces that all expected input workloads of data points whose x- and y-values are outside the area of I number of the triangles (for i=0, 1, . . . , I−1). are equal to the available capacity of resource type k in a period, cₖ. Constraint (5) relates the positive and negative deviations (Oₖₜ and Uₖₜ) with z̅ₖₜ and \tilde{z}ₖₜ. Constraints (6) and (7) ensure that the approximate empirical capacity curve of input workload (z-value) vs. arrival workload (x-value) on plane y=0 is a non-decreasing concave piece-wise curve. Consequently, these two constraints also enforce that the approximate plane-wise surface of the empirical capacity constraint of this embodiment are concave. Constraint (8) ensures that the expected input workload on origin equals zero. Constraint (9) sets the expected input workload of the last end point on x-axis at the available capacity of a resource type k. Constraint (10) sets the z-intercept of a plane I (last plane) at the available capacity of a resource type k. Constraints (11) and (12) are non-negative constraints for all continuous variables.

The approximate surface fitting module has module input data, module output data, and a module procedure listed as follows.

The module input data of the approximate surface fitting module includes:

\tilde{x}ₖₜ: arrival workload (in work-hours) in a period of a data point t, ∀t;

\tilde{y}ₖₜ: initial WIP workload (in work-hours) at a beginning of a period of a data point t, ∀t;

\tilde{z}ₖₜ: input workload (in work-hours) in a period of a data point t, ∀t;

cₖ: available capacity (in work-hours) of resource type k in a period;

aᵢ: an x-value of an i-th end point on the x-axis, i=0, . . . , I; and

sⱼ: a y-value of a j-th end point on the y-axis, where s₀=0 and s₁=cₖ.

The module output data of the approximate surface fitting module includes:

Tₖᵢ: expected input workload that can be inputted for being processed when the y-value (initial WIP workload) is zero and the x-value (arrival workload) is aᵢ, i=0, . . . , I; and

Dₖᵢ: a z-intercept of plane i, which is defined by three points (aᵢ, 0,Tₖᵢ), (aᵢ₊₁,0,T_{k,i+1}), and (0,cₖ,cₖ); and

The module procedure of the approximate surface fitting module is that:

```
For each k
    {
    Solve problem LPₖ
    }
```

After the approximate surface fitting module solves the linear programming module LPₖ for a resource type k, plane i of resource k is defined by the equation z=Dₖᵢ−Aₖᵢx-Bₖᵢy, and the plane parameter calculation module is used to calculate the parameters Aₖᵢ and Bₖᵢ.

The plane parameter calculation module has module input data, module output data, and a module procedure listed as follows.

The module input data of the plane parameter calculation module includes:

cₖ: available capacity of a resource type k in a period;

aᵢ: an x-value of the i-th end point on x-axis, i=0, . . . , I;

Tₖᵢ: expected input workload that can be inputted for being processed when the y-value (initial WIP workload) is zero and the x-value (arrival workload) is aᵢ, i=0, . . . , I; and

Dₖᵢ: a z-intercept of a plane i, which is defined by three points (aᵢ,0,Tₖᵢ), (aᵢ₊₁,0,T_{k,i+1}), and (0,cₖ,cₖ).

The module output data of the plane parameter calculation module includes:

Aₖᵢ: a coefficient of arrival workload of a plane i of a resource type k; and

Bₖᵢ: a coefficient of initial WIP workload of a plane i of a resource type k.

The module procedure of the plane parameter calculation module is that:

```
For each k
  {
  For each i = 0, 1, 2, . . . , I
    {
    ${A}_{ki} = \frac{{D}_{ki} - {T}_{ki}}{{a}_{i}}$
    ${B}_{ki} = \frac{{D}_{ki} - {c}_{k}}{{c}_{k}}$
  }
}
```

The plane reduction module reduces complexity of the empirical capacity constraints of the LPPP model, thereby reducing time required for calculation. In detail, the plane reduction module determines whether or not a difference between arbitrary two of the planes of the plane-wise surface, which is constructed by the approximate surface fitting module, satisfies a predetermined condition; and modifies the plane-wise surface by removing one of said arbitrary two of the planes from the plane-wise surface when the difference between said arbitrary two of the planes satisfies the predetermined condition. For instance, when the plane reduction module determines that the values of D_{k,i1}, A_{k,i1}, and B_{k,i1}, respectively, of plane it of a resource type k are very close to D_{k,i2}, A_{k,i2}, and B_{k,i2}, respectively, of plane i2 of the resource type k, the plane reduction module adds only the plane i1 to the empirical capacity constraint of the resource type in the LPPP model. As an example, if each of the absolute values of the fractions

$$( {D}_{k , i 1} - {D}_{k , i 2} ) / {D}_{k , i {1}^{′}} ( {A}_{k , i 1} - {A}_{k , i 2} ) / {A}_{k , i {1}^{′}} and ( {B}_{k , i 1} - {B}_{k , i 2} ) / {B}_{k , i 1}$$

is less than a very small value (for instance, 10⁻⁶), plane i2 is removed from the approximate plane-wise surface of the empirical capacity of the resource type k. In some embodiments, the plane reduction module may be omitted.

The plane reduction module has module input data, a function, a variable, module output data, and a module procedure listed as follows.

The module input data of the plane reduction module includes:

Aₖᵢ: a coefficient of arrival workload variable of a plane i of a resource type k, •i;

Bₖᵢ: a coefficient of initial WIP workload variable of a plane i of a resource type k, •i; and

δ: a predetermined value which is very small, for instance 10⁻⁶.

The function of the plane reduction module is that:

|x|: an absolute value of x; i.e., |x|=x, if x≥0; |x=−x, if x<0.

The variable of the plane reduction module is:

i′: an index of currently added plane.

The module output data of the plane reduction module is:

Ī(k): a set of all planes that are used in the LPPP model to approximate the empirical capacity surface of resource type k.

The module procedure of the plane reduction module is that:

```
For each k
  {
  Set Ī(k) as an empty set
  Add plane 0 to Ī(k)
  Set i′ = 0
  For each i = 1, 2, . . . , I
    {
  $\begin{matrix}If ( \vert \frac{( {D}_{k , {i}^{′}} - {D}_{k , i} )}{{D}_{k , {i}^{′}}} \vert > δ \\ or \vert \frac{( {A}_{k , {i}^{′}} - {A}_{k , i} )}{{A}_{k , {i}^{′}}} \vert > δ \\ or \vert \frac{( {B}_{k , {i}^{′}} - {B}_{k , i} )}{{B}_{k , {i}^{′}}} \vert > δ )\end{matrix}$
    {
    Add plane i to Ī(k)
    Set i′ = i
    }
  }
}
```

The input coefficient calculation module determines, for each target period of each operation of each product, an input-output relationship between an output quantity in a target period and input quantity or input quantities in at least one period which is not later than the target period according to a predetermined input-output time lag of an operation by calculating input coefficients to express an output quantity in the target period of an operation as a linear function of input quantities in various periods of the operation. Input quantity to an operation in a given period will lead to output quantity of the operation, which may spread over several periods. In addition, the output quantity from an operation in a period will also be equal to the arrival quantity to its downstream operation in the same period. Under a uniform assumption of input rates in a period, the input-output time lag of an operation can be used to determine a fraction of the input quantity in each of the previous periods that contribute to the output quantity of the operation in a particular period.

The input-output relationship is expressed as:

Y_{gpl}=Σ_{q=1}^{p}e_{glpq}X_{gql},l=1, . . . ,L(g),p=1, . . . ,P,g∈G

e_{glpq}: a coefficient for a period q and a target period p of an operation l of a product g, and represents a fraction of an overlapping period between the previous period q and a target input period of the period p to the period q, where the target period has a length equal to that of the target input period, which is obtained by shifting the target period by the predetermined input-output time lag;

L(g): a final operation of the product g;

X_{gql}: an input quantity to an operation l of the product g in the period q; and

Y_{gpl}: an output quantity from an operation l of the product g in the target period p.

In more detail, the input coefficient calculation module has module input data, a function, program variables, module output data, and a module procedure listed as follows.

The module input data of the input coefficient calculation module includes:

τₚ: a number of working days from the beginning of period 1 (time 0) until the end of period p, p=1, . . . , P, and τ₀=0; and

f_{gl}: an input-output time lag of operation l of product g.

The function of the input coefficient calculation module is:

\tilde{p}(τ): the smallest period index p such that τₚ>τ.

The program variables of the input coefficient calculation module include:

q⁻: a period that covers the left input epoch of an output period; and

q⁺: a period that covers the right input epoch of an output period.

The module output data of the input coefficient calculation module includes:

e_{glpq}: the coefficient of X_{gql} in expressing Y_{gpl}, where X_{gql} represents an input quantity to an operation l of a product g in a period q, which is limited by the empirical capacity constraint; and Y_{gpl} represents an output quantity from operation l of product g in a period p (i.e., the target period), which is equal to an arrival quantity from an operation l to an operation l+1 of a product g in the period p.

An input epoch of an operation is obtained by shifting a corresponding output epoch by the input-output time lag of the operation f_{gl}. Let q⁻=\tilde{p}(τₚ₋₁−f_{gl}) and q⁺=\tilde{p}(τₚ−f_{gl}). Two possible cases are described as follows.

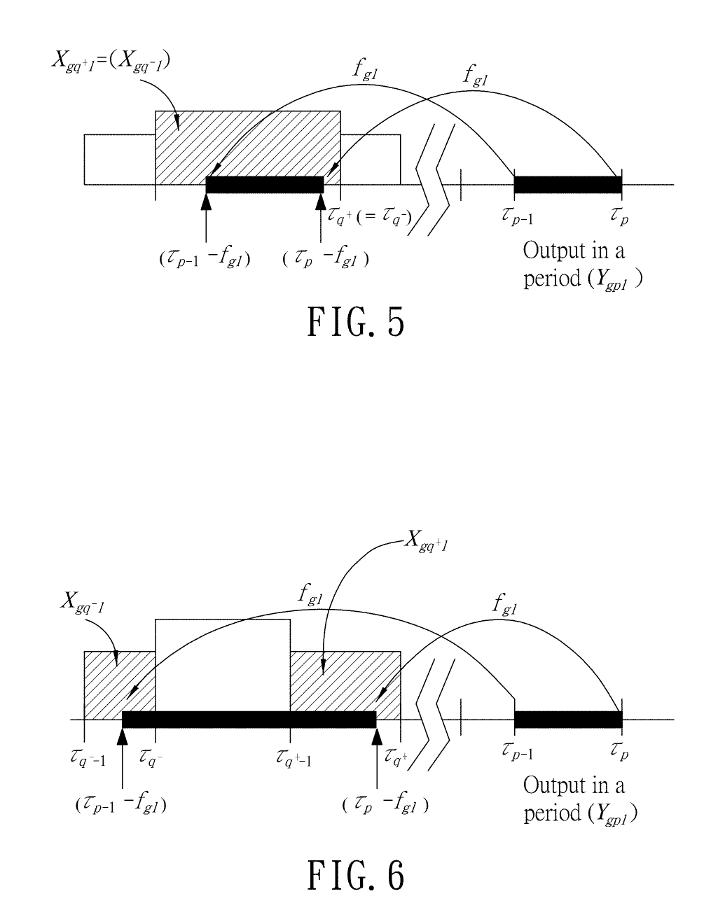

In a first case, the input epoch, i.e., the time interval [τₚ₋₁−f_{gl}, τₚ−f_{gl}], is contained in the same period, as shown in FIG. 5. Thus, q⁻ and q⁺ are equal in this case. By using X_{g,q}_{⁺}_{,l} (or X_{g,q}_{^{−}}_{,l}), Y_{gpl} can be expressed by

$${Y}_{gpl} = \frac{( {τ}_{p} - {f}_{gl} ) - ( {τ}_{p - 1} - {f}_{gl} )}{( {τ}_{{q}^{+}} - {τ}_{{q}^{+} - 1} )} {X}_{g , {q}^{+} , l}$$

That is,

$${e}_{glpq} = 0 , ∀ q such that q < {q}^{+}$$

$${e}_{glpq} = \frac{( {τ}_{p} - {f}_{gl} ) - ( {τ}_{p - 1} - {f}_{gl} )}{( {τ}_{{q}^{+}} - {τ}_{{q}^{+} - 1} )}$$

$${e}_{glpq} = 0 , ∀ q such that q > {q}^{+}$$

In a second case, the time interval [τₚ₋₁−f_{gl}, τₚ−f_{gl}] spans over more than one period, as shown in FIG. 6. Then, Y_{gpl} can be expressed in terms of X_{g,q}_{^{−}}_{,l}, . . . , X_{g,q}_{⁺}_{,l}. Each of these variables has a coefficient that equals the fraction of the length of the overlap interval between its time period and the time interval [τₚ₋₁−f_{gl}, τₚ−f_{gl}] to the length of its time period. The coefficient of X_{g,q}_{^{−}}_{,l} in expressing Y_{gpl} is

$$\frac{{τ}_{{q}^{-}} - ( {τ}_{p - 1} - {f}_{gl} )}{( {τ}_{{q}^{-}} - {τ}_{{q}^{-} - 1} )} ,$$

and the coefficient of X_{g,q}_{⁺}_{,l} in expressing Y_{gpl} is

$$\frac{( {τ}_{p} - {f}_{gl} ) - {τ}_{{q}^{+} - 1}}{( {τ}_{{q}^{+}} - {τ}_{{q}^{+} - 1} )} .$$

For q=q⁻+1, . . . , q⁺−1, the coefficient of variable X_{gql} is 1; that is, all the input quantity in each of these periods can be finished as part of the output quantity in period p. To summarize, Y_{gpl} can be expressed by

$${Y}_{gpl} = \frac{{τ}_{{q}^{-}} - ( {τ}_{p - 1} - {f}_{gl} )}{( {τ}_{{q}^{-}} - {τ}_{{q}^{-} - 1} )} {X}_{g , {q}^{-} , l} + {\sum }_{q = {q}^{-} + 1}^{{q}^{+} - 1} {X}_{gql} + \frac{( {τ}_{p} - {f}_{gl} ) - {τ}_{{q}^{+} - 1}}{( {τ}_{{q}^{+}} - {τ}_{{q}^{+} - 1} )} {X}_{g , {q}^{+} , l} .$$

That is,

$${e}_{glpq} = 0 , ∀ q such that q < {q}^{-}$$

$${e}_{{glpq}^{-}} = \frac{{τ}_{{q}^{-}} - ( {τ}_{p - 1} - {f}_{gl} )}{( {τ}_{{q}^{-}} - {τ}_{{q}^{-} - 1} )}$$

$${e}_{glpq} = 1 , ∀ q = {q}^{-} + 1 , … , {q}^{+} - 1$$

$${e}_{{glpq}^{+}} = \frac{( {τ}_{p} - {f}_{gl} ) - {τ}_{{q}^{+} - 1}}{( {τ}_{{q}^{+}} - {τ}_{{q}^{+} - 1} )}$$

$${e}_{glpq} = 0 , ∀ q such that q > {q}^{+}$$

The module procedure of the input coefficient calculation module is that:

```
For each product g
{
  For each operation l = 1, 2, . . . , L(g)
  {
  For each period p
    {
    Set q⁻ = \tilde{p}(τₚ₋₁ − f_{gl})
    Set q⁺ = \tilde{p}(τₚ − f_{gl})
    If (q⁻ is equal to q⁺)
      {
      For q such that q < q⁺, set e_{glpq} = 0
      $set {e}_{{glpq}^{+}} = \frac{( {τ}_{p} - {f}_{gl} ) - ( {τ}_{p - 1} - {f}_{gl} )}{( {τ}_{{q}^{+}} - {τ}_{{q}^{+} - 1} )}$
      For q such that q > q⁺, set e_{glpq} = 0
      }
      else
      {
      For q such that q < q⁻, set e_{glpq} = 0
      $Set {e}_{{glpq}^{-}} = \frac{{τ}_{{q}^{-}} - ( {τ}_{p - 1} - {f}_{gl} )}{( {τ}_{{q}^{-}} - {τ}_{{q}^{-} - 1} )}$
      For q = q⁻ + 1, . . . , q⁺ − 1, set e_{glpq} = 1
      $Set {e}_{{glpq}^{+}} = \frac{( {τ}_{p} - {f}_{gl} ) - {τ}_{{q}^{+} - 1}}{( {τ}_{{q}^{+}} - {τ}_{{q}^{+} - 1} )}$
      For q such that q > q⁺, set e_{glpq} = 0
      }
  }
}
```

The LPPP calculation module solves an LPPP problem using an LPPP model with empirical capacity constraint that formulates the joint effect of the workloads from the initial WIP and the arrival in a period of a resource type to constrain the input workload to the resource type in the period, thereby determining a release quantity to a first operation of the product in a period.

The LPPP model with empirical capacity constraint has parameters, decision variables, and an objective function listed as follows.

The parameters of the LPPP model include:

ε: a number of working days per period;

u_{gl}: processing time (in work-hours) per product unit of an operation l of a product g;

v_{gp}: unit revenue for a product g in a period p;

h_{gp}: unit inventory holding cost per working day for a product g in a period p;

b_{gp}: unit backorder cost per working day for a product g in a period p;

w_{gp}: unit WIP cost per working day for a product g in a period p;

W_{g,0,l}: an initial WIP level of an operation l of a product g at planning calculation time (current time);

k′_{gl}: a resource type required by an operation l of a product g;

d_{gp}: demand quantity (in product units) for a product g during a period p;

e_{glpq}: a coefficient of X_{gql} in expressing Y_{gpl};

Dₖᵢ: a z-intercept of a plane i of a resource type k;

Aₖᵢ: a coefficient of an arrival workload variable (x variable) in the equation of a plane i for a resource type k;

Bₖᵢ: a coefficient of an initial WIP workload variable (y variable) in the equation of a plane i for a resource type k; and

Ī(k): a set of planes that are used to approximate an empirical capacity surface of a resource type k.

The decision variables of the LPPP model include:

X_{gpl}: input quantity (in product units) to an operation l of a product g in a period p, which is constrained by the empirical capacity constraint of a resource type of the operation l of the product g;

X_{gql}: input quantity (in product units) to an operation l of a product g in a period q, which is constrained by the empirical capacity constraint of a resource type of the operation l of the product g;

Y_{gpl}: output quantity (in product units) from an operation l of a product g in a period p, which is equal to arrival quantity to an operation l+1 of a product g in a period p;

Ŷ_{gp}: output quantity (in product units) of a finished product g in a period p, which is equal to output quantity (in product units) from an operation L(g) of the product g in the period p (i.e., Ŷ_{gp}=Y_{g,p,L(g)});

R_{gp}: release quantity (in product units) to the first operation of a product g in a period p;

W_{gpl}: a WIP level (in product units) of an operation l of a product g at the end of a period p;

I_{gp}: a finished goods inventory level (in product units) of a product g at the end of a period p; and

J_{gp}: a finished goods backordered level (in product units) of a product g at the end of a period p.

The objective function of the LPPP model is that:

$$Maximize {\sum }_{g ∈ G} {\sum }_{p = 1}^{P} {v}_{gp} {\hat{Y}}_{gp} - {\sum }_{g ∈ G} {\sum }_{p = 1}^{P} {\sum }_{l = 1}^{L ( g )} ɛ {w}_{gp} {W}_{gpl} - {\sum }_{g ∈ G} {\sum }_{p = 1}^{P} ɛ {h}_{gp} {I}_{gp} - {\sum }_{g ∈ G} {\sum }_{p = 1}^{P} ɛ {b}_{gp} {J}_{gp} \qquad ( 13 )$$

which is subject to the following constraints (14)-(21):

WIP balance constraint:

W_{gpl}W_{g,p-1,l}+R_{gp}−X_{gpl},l=1,p=1, . . . ,P,g∈G. (14)

W_{gpl}=W_{g,p-1,l}+Y_{g,p,l-1}−X_{gpl},l=2, . . . ,L(g),p=1, . . . ,P,g∈G. (15)

Input Output Relation Equation:

Y_{gpl}=Σ_{q=1}^{p}e_{glpq}X_{gql},l=1, . . . ,L(g),p=1, . . . ,P,g∈G (16)

Finished Goods Inventory Balance:

I_{g,p-1}−J_{g,p-1},Ŷ_{gp}−I_{gp}+J_{gp}=d_{gp},p=1, . . . ,P,g∈G.

(i.e., I_{g,p-1}−J_{g,p-1}+Ŷ_{gp}−d_{gp}=I_{gp}−J_{gp},p=1, . . . ,P,g∈G.) (17)

Empirical Capacity Constraint:

Σ_{{(g,l)|k′}_{_{gl}}_{=l}}u_{gl}X_{gpl}≤Dₖᵢ−AₖᵢΣ_{{(g,l)|k′}_{_{gl}}_{=k}}u_{gl}Y_{g,p,l-1}−BₖᵢΣ_{{(g,l)|k′}_{_{gl}}_{=k}}u_{gl}W_{g,p-1,l},i∈Ī(k),p=1, . . . ,P,∀k∈K. (18)

Final Output Constraint:

Ŷ_{gp}=Y_{g,p,L(g)},p=1, . . . ,P,g∈G (19)

Non-Negativity Constraint:

W_{gpl},X_{gpl},Y_{gpl}≥0,l=1, . . . ,L(g),p=1, . . . ,P,g∈G. (20)

Ŷ_{gp},R_{gp},I_{gp},J_{gp}≥0,p=1, . . . ,P,g∈G. (21)

Objective function (13) is to maximize the revenue minus WIP inventory cost and finished goods inventory and backorder costs. Constraints (14) and (15) are both WIP inventory balance constraints. Constraint (14) used for operation l=1 enforces that the WIP level of the first operation of product g at the end of period p (W_{gpl}) is equal to the WIP level at the beginning of the period (W_{g,p-1,l}) plus the release quantity to the first operation (R_{gp}) and minus the input quantity to the first operation in the period (X_{gpl}). Similarly, Constraint (15) used for operation l=2, . . . , L(g) enforces that the WIP level of product g for operation l at the end of period p (W_{gpl}) is equal to the WIP level at the beginning of the period (W_{g,p-1,l}) plus the arrival quantity from preceding operation (Y_{g,p,l-1}) and minus the input quantity to the operation in the period (X_{gpl}). The difference between Constraints (14) and (15) is the arrivals: one is the new release quantity into the factory for the first operation; and the other is the output quantity from the preceding operation. Constraint (16) is an input-output equation for an operation of a product in a period. Constraint (17) is an inventory balance constraint on finished products which ensures that the inventory-minus-backorder level at the end of a period is equal to the inventory-minus-backorder level at the beginning of the period plus the finished product output in the period (\tilde{Y}_{gp}) and minus the demand in the period (d_{gp}) Constraint (18) is an empirical capacity constraint of a resource type in a period that limits the workload of all input quantities (X_{gpl}) under the plane-wise surface developed in previous modules (i.e., the approximate surface fitting module, the plane parameter calculation module and the plane reduction module). The limitation on input workload of a resource type in a period is jointly expressed by the workload from the arrival quantity in the period (output quantity from the preceding operation, Y_{g,p,l-1}) and the workload from the initial WIP of the period (W_{g,p-1,l}) of various operations that use the resource type. Constraint (19) makes the output quantity of a finished product equal the output from the last operation of the product. Constraints (20) and (21) are non-negative constraints for all continuous variables.

The LPPP calculation module has module input data, module output data, and a module procedure listed as follows.

The module input data of the LPPP calculation module includes:

ε: a number of working days per period;

u_{gl}: processing time (in work-hours) per product unit of an operation l of a product g;

v_{gp}: unit revenue for a product g in a period p;

h_{gp}: unit inventory holding cost per working day for a product g in a period p;

b_{gp}: unit backorder cost per working day for a product g in a period p;

w_{gp}: unit WIP cost per working day for a product g in a period p;

W_{g,0,l}: an initial WIP level of an operation l of a product g at planning calculation time (current time); k′_{gl}: a resource type required by an operation l of a product g;

d_{gp}: a demand quantity (in product units) for a product g during a period p;

e_{glpq}: a coefficient of X_{gql} in expressing Y_{gpl};

Dₖᵢ: a z-intercept of a plane i of a resource type k;

Aₖᵢ: a coefficient of an arrival workload variable (x variable) in the equation of a plane i for a resource type k;

Bₖᵢ: a coefficient of an initial WIP workload variable (y variable) in the equation of a plane i for a resource type k; and

Ī(k): a set of planes that are used to approximate the empirical capacity surface of a resource type k.

The output data of the LPPP calculation module includes:

X_{gpl}: input quantity to an operation l of a product g in a period p, constrained by the empirical capacity constraint of its resource type;

R_{gp}: release quantity to the first operation of a product g in a period p;

I_{gp}: a finished goods inventory level of a product g at the end of a period p; and

J_{gp}: a finished goods backordered level of a product g at the end of a period p.

The module procedure of the LPPP calculation module is to solve the LPPP problem.

Finally, the computer system may display information of the above calculations, which may include module input data, module output data, parameters, graphs that correspond to the established model, and each piece of user desired data, to the user through the user interface device (e.g., by displaying the information on a screen, printing the information on paper, etc.), so that the user may execute production plans accordingly, thereby optimizing the production.

In summary, the empirical capacity model developed in this disclosure maps the joint workload effects from the initial WIP and arrival of a resource type in a period to the input workload of the resource type in the period. This relationship is extrapolated from the two primitive relationships: one relates initial WIP workload of a resource type in a period to the input workload of the resource type in the period when there is no arrival to the resource type in the period; and the other relates the arrival workload of a resource type in a period to the input workload of the resource type in the period when there is no initial WIP of the resource type in the period. By virtue of the six modules introduced in the embodiment and using the empirical capacity model, production plans may thus be optimized.

In the description above, for the purposes of explanation, numerous specific details have been set forth in order to provide a thorough understanding of the embodiment (s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of production planning for a group of products, implemented by a computer system, and comprising steps of:
(a) collecting sample data points for a resource type, each of the sample data points representing an individual relationship among arrival workload, initial work-in-process (WIP) workload and input workload of the resource type in a period; and
(b) establishing a capacity model that models a relationship among arrival workloads, initial WIP workloads and expected input workloads of the resource type according to the sample data points collected in step (a), a first predetermined objective function, and a first set of predetermined constraints.

2. The method of claim 1, wherein the sample data points collected in step (a) constructs a curved surface in a three-dimensional (3-D) coordinate system that includes an x-axis representing arrival workloads, a y-axis representing initial WIP workloads, and a z-axis representing input workloads, and step (b) includes constructing a plane-wise surface that includes a set of planes in the 3-D coordinate system by fitting the curved surface constructed by the sample data points based on the first predetermined objective function and the first set of predetermined constraints.

3. The method of claim 2, wherein step (b) includes:
(b-1) for a resource type k in a linear programming LPₖ, optimizing the first predetermined objective function under the first set of predetermined constraints to obtain parameters Tₖᵢ and Dₖᵢ, for i=0, 1, . . . , I, and I is a predetermined parameter that is a positive integer, wherein the first predetermined objective function is
$$Minimize {\sum }_{i = 0}^{I - 1} {\sum }_{t ∈ {Φ}_{ki}} \frac{1}{{θ}_{ki}} ( {O}_{kt} + {U}_{kt} ) ,$$
and the first set of predetermined constraints includes:
$$\begin{matrix}{D}_{ki} = {T}_{k , i + 1} - \frac{{T}_{k , i + 1} - {T}_{ki}}{{a}_{i + 1} - {a}_{i}} \times {a}_{i + 1} i = 0 , … , I - 1 ; \\ {\overline{z}}_{kt} = {D}_{ki} + \frac{{T}_{k , i + 1} - {T}_{ki}}{{a}_{i + 1} - {a}_{i}} \times {\tilde{x}}_{kt} + \frac{{c}_{k} - {D}_{ki}}{{s}_{1} - {s}_{0}} \times {\tilde{y}}_{kt} , \\ ∀ t such that ( {\tilde{x}}_{kt} , {\tilde{y}}_{kt} ) ∈ {Ψ}_{ki} , i = 0 , … , I - 1 ; \\ {\overline{z}}_{kt} = {c}_{k} , ∀ t such that ( {\tilde{x}}_{kt} , {\tilde{y}}_{kt} ) ∈ {Ψ}_{kI} ; \\ {O}_{kt} - {U}_{kt} = {\overline{z}}_{kt} - {\tilde{z}}_{kt} , ∀ t ; \\ {T}_{k , i + 1} \geq {T}_{k , i} , i = 0 , … , I - 1 ; \\ \frac{{T}_{k , i + 1} - {T}_{ki}}{{a}_{i + 1} - {a}_{i}} \leq \frac{{T}_{ki} - {T}_{k , i - 1}}{{a}_{i} - {a}_{i - 1}} , i = 1 , … , I - 1 ; \\ {T}_{k 0} = 0 ; \\ {T}_{kI} = {c}_{k} ; \\ {D}_{kI} = {c}_{k} ; \\ {T}_{ki} , {D}_{ki} \geq 0 , ∀ i ; and \\ {O}_{kt} , {U}_{kt} \geq 0 , ∀ t ,\end{matrix}$$
where
k represents the resource type;
\tilde{x}ₖₜ is an x-value of a data point t in the 3-D coordinate system, ∀t, and represents an arrival workload of the data point t, the data point t being one of the sample data points collected in a period t;
\tilde{y}ₖₜ is a y-value of the data point t in the 3-D coordinate system, ∀t, and represents an initial WIP workload of the data point t;
\tilde{z}ₖₜ is a z-value of the data point t in the 3-D coordinate system, ∀t, and represents an input workload of the data point t;
cₖ represents available capacity of the resource type k in a period;
aᵢ represents an x-value of an i-th one of a number I of predetermined points on the x-axis, for i=0, 1, . . . , I;
s₀ represents a y-value of a predetermined point on the y-axis, which is equal to zero;
s₁ represents a y-value of another predetermined point on the y-axis, which is equal to cₖ;
Ψₖᵢ represents a set of {(x,y)|cₖx+aᵢy−aᵢcₖ>0 and cₖx+aᵢ₊₁y−aᵢ₊₁cₖ≤0}, for i=0, 1, . . . , I−1;
Ψ_{kI} represents a set of {(x,y)|cₖx+a_{I}y−a_{I}cₖ>0};
Φₖᵢ represents a set of {t|(\tilde{x}ₖₜ,\tilde{y}ₖₜ)∈Ψₖᵢ}, i=0, . . . , I;
θₖᵢ represents a number of data points in Φₖᵢ;
Tₖᵢ represents an expected input workload when an initial WIP workload corresponding thereto is zero and an arrival workload corresponding thereto is aᵢ, for i=0 . . . , I;
Dₖᵢ represents a z-intercept of a plane i, which is an i-th one of the planes of the plane-wise surface and which is defined by points (aᵢ,0,Tₖᵢ), (aᵢ₊₁,0,T_{k,i+1}), and (0,cₖ,cₖ), for i=0, 1, . . . , I−1;
Oₖₜ represents an over-estimated input workload corresponding to the data point t in LPₖ, ∀t, where LPₖ represents the capacity model of the resource type k;
Uₖₜ represents an under-estimated input workload corresponding to the data point t in LPₖ, ∀t; and
z̅ₖₜ is a z-value corresponding to the data point t whose x-value is \tilde{x}ₖₜ and y-value is \tilde{y}ₖₜ in LPₖ, ∀t, and represents the expected input workload corresponding to (\tilde{x}ₖₜ, \tilde{y}ₖₜ) of the data point t, ∀t.

4. The method of claim 2, further comprising a step of:
(c) determining a release quantity to a first operation of the product in a period according to the capacity model obtained in step (b), a second objective function and a second set of predetermined constraints.

5. The method of claim 4, wherein, in step (c), the second objective function is
Maximize
$${\sum }_{g ∈ G} {\sum }_{p = 1}^{P} {v}_{gp} {\hat{Y}}_{gp} - {\sum }_{g ∈ G} {\sum }_{p = 1}^{P} {\sum }_{l = 1}^{L ( g )} ɛ {w}_{gp} {W}_{gpl} - {\sum }_{g ∈ G} {\sum }_{p = 1}^{P} ɛ {h}_{gp} {I}_{gp} - {\sum }_{g ∈ G} {\sum }_{p = 1}^{P} ɛ {b}_{gp} {J}_{gp} ,$$
and the second set of predetermined constraints includes:
$${W}_{gpl} = {W}_{g , p - 1 , l} + {R}_{gp} - {X}_{gpl} , l = 1 , p = 1 , … , P , g ∈ G . ;$$
$${W}_{gpl} = {W}_{g , p - 1 , l} + {Y}_{g , p , l - 1} - {X}_{gpl} , l = 2 , … , L ( g ) , \\ p = 1 , … , P , g ∈ G ;$$
$${Y}_{gpl} = {\sum }_{q = 1}^{p} {e}_{glpq} {X}_{gql} , l = 1 , … , L ( g ) , p = 1 , … , P , g ∈ G ;$$
$${I}_{g , p - 1} - {J}_{g , p - 1} + {\hat{Y}}_{gp} - {I}_{gp} + {J}_{gp} = {d}_{gp} , p = 1 , … , P , g ∈ G ;$$
$${\sum }_{\{ ( g , l ) \vert {k}_{gl}^{′} = k \}} {u}_{gl} {X}_{gpl} \leq {D}_{ki} - {A}_{ki} {\sum }_{\{ ( g , l ) \vert {k}_{gl}^{′} = k \}} {u}_{gl} {Y}_{g , p , l - 1} - {B}_{ki} {\sum }_{\{ ( g , l ) \vert {k}_{gl}^{′} = k \}} {u}_{gl} {W}_{g , p - 1 , l ,}$$
$$i ∈ \overline{I} ( k ) , p = 1 , ⋯ , P , ∀ k ∈ K ;$$
$${\hat{Y}}_{gp} = {Y}_{g , p , L ( g )} , p = 1 , … , P , g ∈ G ;$$
$${W}_{gpl} , {X}_{gpl} , {Y}_{gpl} \geq 0 , l = 1 , … , L ( g ) , p = 1 , ⋯ , P , g ∈ G ;$$
$$and$$
$${\hat{Y}}_{gp} , {R}_{gp} , {I}_{gp} , {J}_{gp} \geq 0 , p = 1 , ⋯ , P , g ∈ G ;$$
where:
g represents the product;
G represents the product group;
l represents an l-th operation;
L(g) represents a final operation, which is an L(g)-th operation of the product g;
p represents a period which is a p-th one of a number P of predefined periods;
ε represents a number of working days per period;
u_{gl} represents processing time per product unit of an operation l of the product g;
v_{gp} represents unit revenue for the product g in a period p;
h_{gp} represents unit inventory holding cost per working day for the product g in the period p;
b_{gp} represents unit backorder cost per working day for the product g in the period p;
w_{gp} represents unit WIP cost per working day for the product g in the period p;
W_{g,0,l} represents an initial WIP level of the operation l of the product g at current time;
k′_{gl} represents a resource type required by the operation l of the product g;
d_{gp} represents a demand quantity for the product g during the period p;
e_{glpq} is a coefficient of X_{gql} in expressing Y_{gpl};
Dₖᵢ represents a z-intercept of a plane i, which is an i-th one of the planes of the plane-wise surface for the resource type k and which is expressed by an equation of z=Dₖᵢ−Aₖᵢx−Bₖᵢy;
Ī(k) represents a set of the planes of the plane-wise surface for the resource type k;
X_{gpl} represents an input quantity to the operation l of the product g in the period p;
X_{gql} represents an input quantity to the operation l of the product g in the period q;
Y_{gpl} represents an output quantity from the operation l of the product g in the period p;
Ŷ_{gp} represents an output quantity of finished goods of the product g in the period p, and is equal to an output quantity from the operation L(g) of the product g in the period p, which is represented by Y_{g,p,L(g)};
R_{gp} represents a release quantity to the first operation of the product g in the period p;
W_{gpl} represents a WIP level of the operation l of the product g at the end of the period p;
I_{gp} represents a finished goods inventory level of the product g at the end of the period p; and
J_{gp} represents a finished goods backordered level of the product g at the end of the period p.

6. The method of claim 5, further comprising steps of:
(c) determining, for an operation of the product, an input-output relationship between an output quantity in a target period and an input quantity or input quantities in at least one period which is not later than the target period according to a predetermined input-output time lag of the operation; and
(d) determining a release quantity to a first operation of the product in a period according to the capacity model that is obtained in step (b) and that is modified according to the predetermined condition, the input-output relationship obtained in step (c), a second objective function and a second set of predetermined constraints.

7. The method of claim 2, further comprising a step of:
(c) determining, for an operation of the product, an input-output relationship between an output quantity in a target period and an input quantity or input quantities in at least one period which is not later than the target period according to a predetermined input-output time lag of the operation.

8. The method of claim 7, wherein, in step (c), the input-output relationship is expressed as:
Y_{gpl}=Σ_{q=1}^{p}e_{glpq}X_{gql},l=1, . . . ,L(g),p=1, . . . ,P,g∈G
, where
g represents the product;
G represents the product group;
p represents the target period, which is a p-th one of a number P of predefined periods;
q represents one of the predefined periods which is not later than the target period;
e_{glpq} is an input coefficient for an operation l of the product g, and represents a fraction of an overlapping period between the period q and a target input period to the period q, where the target period has a length equal to that of the target input period, which is obtained by shifting the target output period by the predetermined input-output time lag;
L(g) represents a final operation of the product g;
X_{gql} represents an input quantity to an operation l of the product g in the period q; and
Y_{gpl} represents an output quantity from an operation l of the product g in the target period p.

9. The method of claim 2, wherein step (b) further includes determining whether or not a difference between arbitrary two of the planes of the plane-wise surface, which is constructed based on the first predetermined objective function and the first set of predetermined constraints, satisfies a predetermined condition; and modifying the plane-wise surface by removing one of said arbitrary two of the planes from the plane-wise surface when the difference between said arbitrary two of the planes satisfies the predetermined condition.

10. The method of claim 9, wherein each of an i-th one of the planes of the plane-wise surface is expressed by Dₖᵢ−Aₖᵢx−Bₖᵢy, and the predetermined condition for the i-th one of the planes and an i′-th one of the planes is:
$$\vert ( {D}_{k , {i}^{′}} - {D}_{k , i} ) / {D}_{k , {i}^{′}} \vert < g ;$$
$$\vert ( {A}_{k , {i}^{′}} - {A}_{k , i} ) / {A}_{k , {i}^{′}} \vert < g ; and$$
$$\vert ( {B}_{k , {i}^{′}} - {B}_{k , i} ) / {B}_{k , {i}^{′}} \vert < g ;$$
where δ is a predetermined constant.

11. A method of production planning for a group of products, comprising steps of:
(a) receiving, by a processor, a plurality of sample data pieces for a resource type from at least one of a storage device or an input device, each of the sample data pieces representing an individual relationship among arrival workload, initial work-in-process (WIP) workload and input workload of the resource type; and
(b) generating, by a processor, capacity model data representing a capacity model that models a relationship among arrival workload, initial WIP workload and expected input workload of the resource type according to the sample data pieces received in step (a), first pre-stored objective function data representing a first predetermined objective function, and first pre-stored constraint data representing a first set of predetermined constraints.

12. The method of claim 11, further comprising steps of:
(c) generating, by a processor, input-output relationship data representing, for each operation of a product, an input-output relationship between an output quantity in a target period and an input quantity or input quantities in at least one period which is not later than the target period according to pre-stored time lag data representing a predetermined input-output time lag of an operation;
(d) generating, by a processor, release quantity data representing a release quantity to a first operations of the product in a period according to the capacity model data, the input-output relationship data, second pre-stored objective function data representing a second predetermined objective function, and second pre-stored constraint data representing a second set of predetermined constraints; and
(e) displaying, by a user interface device, information represented by the release quantity data.

13. A computer system for production planning for a group of products, said computer system comprising:
an input device for input operation of a user;
a storage device storing first pre-stored objective function data representing a first predetermined objective function, and first pre-stored constraint data representing a first set of predetermined constraints;
a processor coupled to said input device and said storage device, and configured to:
receive a plurality of sample data pieces for a resource type from at least one of said storage device or said input device, each of the sample data pieces representing an individual relationship among arrival workload, initial work-in-process (WIP) workload and input workload of the resource type; and
generate capacity model data representing a capacity model of a resource type that models the relationship among arrival workload, initial WIP workload and expected input workload of the resource type according to the sample data pieces, the first pre-stored objective function data, and the first pre-stored constraint data.

14. The computer system of claim 13, wherein said storage device further storing pre-stored time lag data representing a predetermined input-output time lag of an operation, second pre-stored objective function data representing a second predetermined objective function, and second pre-stored constraint data representing a second set of predetermined constraints;
wherein said processor is further configured to:
generate input-output relationship data representing, for an target period of an operation of a product, an input-output relationship between an output quantity in a target period and an input quantity or input quantities in at least one period which is not later than the target period according to pre-stored time lag data representing a predetermined input-output time lag of an operation; and
generate release quantity data representing a release quantity to a first operation of the product in a period according to the capacity model data, the input-output relationship data, the second pre-stored objective function data, and the second pre-stored constraint data;
said computer system further comprising a user interface device configured to display information represented by the release quantity data.
